(19) United States
(12) Patent Application Publication
(10) Pub. No.: US 2006/0101927 A1
(43) Pub. Date: May 18, 2006

(54) Analytical measurement meters with location determination capability

(76) Inventor: Gerald W. Blakeley III, Lincoln, MA (US)

Correspondence Address: BRIAN M. DINGMAN;MIRICK, O'CONNELL, DEMALLIE & LOUGEE, LLP, 100 FRONT STREET, WORCESTER, MA, 01608, US

(21) Appl. No.: 11/281,909

(22) Filed: Nov. 17, 2005

Related U.S. Application Data
(60) Provisional application No. 60/629,019, filed on Nov. 18, 2004.

(51) Int. Cl. G01D 3/10; G01D 9/28; G01D 7/02; G01D 21/02

(52) U.S. Cl. 73/866.1; 702/189

(57) ABSTRACT

An instrument and a method for making measurements that are coupled with the location at which a measurement is made. There is provided an instrument that is capable of making an analytical measurement, the instrument having an instrument locator capability. When the analytical measurement is made, the location is associated with the measurement and stored in memory.

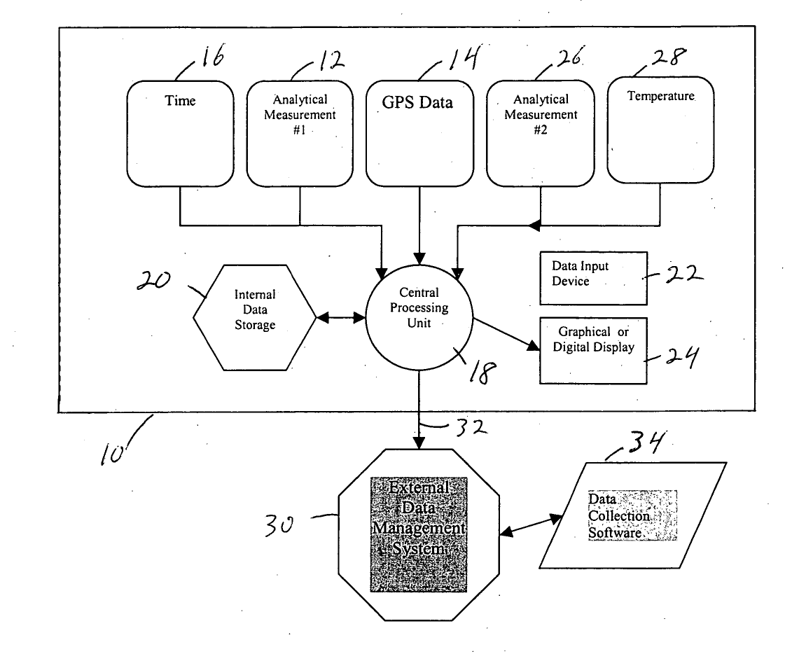

### CROSS REFERENCE TO RELATED APPLICATION

This application claims priority of Provisional application Ser. No. 60/629,019, filed on Nov. 18, 2004.

### FIELD OF THE INVENTION

This invention relates to an analytical meter with on-board location-determining capability.

### BACKGROUND OF INVENTION

Analytical meters and measurement devices are commonly used for a variety of applications. Many times, the measurement results are recorded by the user. These instruments are most times portable, and can be used at an indoor or outdoor location at which measurements need to be made. Two simple examples are multimeters, which are used indoors and outdoors to measure electrical parameters such as voltage, current and resistance, and anemometers, which are used outdoors to determine wind speed.

In some situations, it is necessary to record the location at which one or more such measurements have been made. This is particularly the case with outdoor measurements of environmental-type parameters. This information is typically recorded on a chart or map or the like that serves as a physical record of the location at which each measurement was made. Most times, the time at which the measurement was made is also recorded by the operator.

### SUMMARY OF INVENTION

This invention comprises analytical meters and measurement devices (hereinafter generally referred to as “meters” or “instruments”) which can log location by means such as GPS, associate the location with relevant measured analytical information, and transfer this associated information to a computer or other data management system. The transfer can be accomplished over a wired or wireless network.

This invention features a method of making measurements that are coupled with the location at which a measurement is made, comprising providing an instrument that is capable of making an analytical measurement, providing as part of the instrument an instrument locator capability, using the instrument to make an analytical measurement, using the instrument locator capability to determine the location of the instrument when the analytical measurement is made, and associating the location with the measurement.

The method may further comprise providing as part of the instrument a time determining capability, and using the instrument to determine the time at which the measurement is made. The time can also include the date. The method may further comprise saving the analytical measurement and the location in a manner in which the two are associated with one another.

The instrument may make a measurement of one or more chemical properties, such as pH, oxidation-reduction potential, dissolved oxygen, ion concentration, combustible gas, carbon monoxide, carbon dioxide and a gas analyzer. The instrument may make an electrical measurement, such as conductivity, voltage, current, frequency, capacitance, resistance, electromagnetic field radiation and ground resistance. The instrument may make a physical or environmental measurement, such as sound, light, photometer measurement, wind, shock, temperature, humidity, moisture and turbidity.

The instrument locator capability may comprise a GPS sensor or another receiver for receiving satellite-based signals, or may comprise an on-board system or a terrestrial-based broadcast system. The instrument may further be provided with a timekeeping capability to determine the time when the analytical measurement is made; the time can include the date. The time can be associated with the measurement and the location. The method may further comprise saving the analytical measurement, the location and the time in a manner in which the three are associated with one another. The stored information may be transmitted to a remote data management system.

This invention also features an instrument for making measurements and coupling the measurements with the location at which a measurement is made, comprising means for making an analytical measurement, means for determining the location of the instrument when the analytical measurement is made, and means for associating the location with the measurement. The instrument may further include means for determining the time when the analytical measurement is made, and means for associating the time, the measurement and the location. There may be a memory for saving the associated time, measurement and location.

### DESCRIPTION OF THE PREFERRED EMBODIMENTS OF THE INVENTION

The preferred embodiment of this invention is illustrated in the attached block diagram of an inventive analytical meter 10 with location-determination capability, and including an optional data management system with which the meter communicates. The means to determine location of the meter can employ any viable technology; currently, a Global Positioning System (GPS) receiver 14 is the preferred technology because it is effective, reliable, accurate to the requirements of the expected markets for the product, commercially available, and relatively inexpensive. Another satellite-based location determining system is GLONAS. Terrestrial broadcast location-determination systems are also a viable option.

The inventive meters have all of the typical meter functionality, accomplished by any available technology for making the relevant measurement(s). Meter 10 has on-board capability to make two different analytical measurements using devices 12 and 26, along with time measurement 16 (which can use the GPS signal), and temperature measurement 28. The location information is then associated with the measurement(s), and also typically with the time at which the measurement is taken (which can also include the date), in CPU 18. This associated information is then stored in storage 20, which typically comprises a database into which the data is placed in a manner that maintains their mutual association. User display 24 is the user output device, and input device 22 can comprise push buttons and the like as commonly available in analytical meters. The result is that the measurement data is tied to location, which can be useful in many situations. For example, mapping of the measured parameter can be accomplished through a series of measurements taken at various locations within an area of interest.

The invention accomplishes a more efficient means of collecting, and optionally managing the measured data. The invention may include an internal or external data management system 30, which is typically loaded on a PC. The inventive meter 10 can communicate data to system 30, either through a hard connection, or wirelessly, both illustrated at 32. Data collection software 34 allows data manipulation, display and the like.

A non-limiting list of the types of meters included within the scope of the invention follows. Along with the basic function of such meters is a description of typical additional measurement capabilities accomplished by each such embodiment of the invention.

pH measurements typically would include information on pH reading, temperature, time and position.

Conductivity measurements typically would include information on conductivity reading, temperature, time and position. Other calculated information, such as total dissolved solids (TDS) or salinity may also be included.

ORP (oxidation-reduction potential) measurements typically would include information on ORP reading, time and position.

Temperature measurements typically would include information on temperature, time and position.

Dissolved Oxygen measurements typically would include information on % saturation dissolved oxygen, and/or dissolved oxygen concentration, barometric pressure, temperature, time and position.

Ion selective electrode measurements typically would include information on concentration, ion being measured, temperature, time and position.

A sound measurement typically would include information on sound intensity, time and position.

A combustible gas measurement typically would include information on the gas being measured, concentration, barometric pressure, temperature, time and position.

A carbon monoxide gas measurement typically would include information on the concentration of carbon monoxide, barometric pressure, temperature, time and position.

A carbon dioxide gas measurement typically would include information on the concentration of carbon dioxide, barometric pressure, temperature, time and position.

A light intensity measurement typically would include information on light intensity, time and position.

A humidity measurement in atmosphere typically would include information on humidity level, temperature, time and position. Other calculated information, such as dew point, may also be included.

A moisture in solid sample measurement typically would include information on moisture level, temperature, time and position.

A turbidity measurement typically would include the turbidity value, temperature, time and position.

A photometer measurement typically would include the transmission value, calculated concentration of the compound or property of interest of the sample, temperature, time and position.

A wind speed measurement (anemometer) typically would include information on the air velocity, barometric pressure, temperature, time and position.

A gas analyzer measurement typically would include information on the gas being measured, concentration, barometric pressure, temperature, time and position.

A voltage measurement typically would include information on the type of measurement (AC, DC, true RMS), voltage measurement, temperature, time and position.

An electrical current measurement typically would include information on the current measurement, temperature, time and position.

A capacitance measurement typically would include information on the capacitance measurement, temperature, time and position.

An electrical resistance measurement typically would include information on the resistance measurement, temperature, time and position.

An electrical frequency measurement typically would include information on the frequency measurement, voltage, current, temperature, time and position.

A electromagnetic field radiation (EMF) measurement typically would include information on the radiation intensity of the field, temperature, time and position.

A ground resistance measurement typically would include information on the resistance measurement, temperature, time and position.

A mechanical shock measurement typically would include information on the shock energy measurement, temperature, time, humidity, and position. As a logging device (e.g. with on-board data storage), this product could be used in a mobile or shipping application to record extreme shock events with relevant information such as time, location and temperature.

Other embodiments will occur to those skilled in the art and are within the following claims.

What is claimed is:

1. A method of making measurements that are coupled with the location at which a measurement is made, comprising:
providing an instrument that is capable of making an analytical measurement;
providing as part of the instrument an instrument locator capability;
using the instrument to make an analytical measurement;
using the instrument locator capability to determine the location of the instrument when the analytical measurement is made; and
associating the location with the measurement.

2. The method of claim 1, further comprising providing as part of the instrument a time determining capability, and using the instrument to determine the time at which the measurement is made.

3. The method of claim 1, further comprising saving the analytical measurement and the location in a manner in which the two are associated with one another.

4. The method of claim 1, wherein the instrument makes a measurement of one or more chemical properties.

5. The method of claim 4, wherein the property is selected from the group of properties including pH, oxidation-reduction potential, dissolved oxygen, ion concentration, combustible gas, carbon monoxide, carbon dioxide and a gas analyzer.

6. The method of claim 1, wherein the instrument makes an electrical measurement.

7. The method of claim 6, wherein the electrical measurement is selected from the group of electrical measurements including conductivity, voltage, current, frequency, capacitance, resistance, electromagnetic field radiation and ground resistance.

8. The method of claim 1, wherein the instrument makes a physical or environmental measurement.

9. The method of claim 8, wherein the physical or environmental measurement is selected from the group of measurements including sound, light, photometer measurement, wind, shock, temperature, humidity, moisture and turbidity.

10. The method of claim 1, wherein the instrument locator capability comprises a GPS sensor.

11. The method of claim 1, wherein the instrument locator capability comprises a receiver for receiving satellite-based signals.

12. The method of claim 1, further comprising providing a timekeeping capability, using the instrument timekeeping capability to determine the time when the analytical measurement is made, and associating the determined time with the measurement and the location.

13. The method of claim 12, further comprising saving the analytical measurement, the location and the time in a manner in which the three are associated with one another.

14. The method of claim 1, further comprising transmitting the location and the measurement to a remote data management system.

15. An instrument for making measurements and coupling the measurements with the location at which a measurement is made, comprising:
means for making an analytical measurement;
means for determining the location of the instrument when the analytical measurement is made; and
means for associating the location with the measurement.

16. The instrument of claim 15, further comprising means for determining the time when the analytical measurement is made.

17. The instrument of claim 16, further comprising means for associating the time, the measurement and the location.

18. The instrument of claim 17, further comprising a memory for saving the associated time, measurement and location.

19. A method of making measurements that are coupled with the location and time at which a measurement is made, comprising:
providing an instrument that is capable of making an analytical measurement;
providing as part of the instrument an instrument locator capability;
providing as part of the instrument a time determining capability;
using the instrument to make an analytical measurement;
using the instrument locator capability to determine the location of the instrument when the analytical measurement is made;
using the time determining capability to determine the time at which the measurement is made; and
saving the analytical measurement, the location and the time in a manner in which the three are associated with one another.
